(19) United States
(12) Patent Application Publication
(10) Pub. No.: US 2024/0237691 A1
(43) Pub. Date: Jul. 18, 2024

(54) MANNA COMPOSITIONS AND METHODS OF MAKING THE SAME

(71) Applicant: Gerald E. Aardsma, Loda, IL (US)

(72) Inventor: Gerald E. Aardsma, Loda, IL (US)

(21) Appl. No.: 18/412,013

(22) Filed: Jan. 12, 2024

Related U.S. Application Data
(60) Provisional application No. 63/438,584, filed on Jan. 12, 2023.

(51) Int. Cl. A23L 29/00; A23L 3/40

(52) U.S. Cl. CPC A23L 29/035; A23L 3/40

(57) ABSTRACT

Provided herein are manufactured forms of the primary features of manna, along with mixtures and compositions comprising such.

### RELATED APPLICATIONS

This application claims the benefit of priority to U.S. Provisional Application No. 63/438,584, filed Jan. 12, 2023, the entire contents of which are incorporated herein by reference.

### BACKGROUND

The primary record of manna is found in chapter 16 of the biblical book of Exodus. The Israelites called it man (derived from the word ‘what,’ or ‘what is it’), and described it as being like coriander seed, white, and its taste was like wafers made with honey. Unfortunately, the biblical historical account of the Exodus nowhere explicitly addresses what manna is composed of. While theories exist, the chemical makeup of manna has remained a mystery for thousands of years. In addition, the biblical historical account of the Exodus reveals that the Israelite nation experienced zero population growth during the roughly forty years they lived in the desert where the manna was produced and consumed. The biblical historical account of the Exodus nowhere addresses this phenomenon.

### SUMMARY

Provided herein is what is believed to be the primary chemical makeup of manna, along with mixtures and compositions comprising such which lack harmful substances potentially contributing to the reduction in population growth during Exodus.

Methods of making manna as its primary makeup as well as its potential use as a food substance are also provided.

### DETAILED DESCRIPTION

Manna was described in the Book of Numbers as arriving with the dew during the night (Numbers 11:9). Exodus adds that evaporation of the dew left behind a fine, flake-like solid which had to be collected before it was melted by the heat of the desert sun. (Exodus 16:21). Regardless, no manna was to be found on Sabbath mornings (Exodus 16:27).

### A. The Stockyard Gas Theory of Manna

As explained in Exodus, Manna would spoil if left overnight preceding any of the six weekly workdays, but it would not spoil when left overnight preceding the sabbath. Given the deduction that manna is sensitive to ambient air, this observation concludes that there was something different about the air in the Israelites' camps the night before the sabbath than on other nights of the week. The Israelites behaved differently on the sabbath than on every other day of the week. They were forbidden to work on the sabbath. This regulation was taken very seriously. The biblical record teaches us that sabbath breaking was a capital crime in ancient Israel. Moses had a man executed for gathering sticks for his fire on the sabbath, for example.

The Israelites were pastoralists. They kept vast herds of livestock: sheep, goats, and cattle. The livestock would have been led away from the camp to graze desert vegetation each morning, and then herdsmen and livestock would have returned to camp each evening and here is the critical point, except for evenings before sabbaths.

The herds could not be taken from the camp to graze desert vegetation sabbath mornings. This would be work-sabbath-breaking. It would be work for the herdsmen, and it would be work for the herds, and work was forbidden for both the herdsmen and the herds on the sabbath as we have already seen from Exodus 20:8-11. The sabbath was to be a day of rest. The herdsmen were to rest and the herds were to rest on the sabbath. But there would be insufficient vegetation for vast herds to graze on in the camp. Yet the livestock could not be left unfed on the sabbath.

The solution was for the herdsmen and the herds to remain out in the fields on the sabbath. They would not have returned to the camp the evening before the sabbath. High concentrations of animals significantly change ambient air. Archaeology teaches us that the Israelites' herds were kept outside the camp, surrounding it at night. There would have been several advantages to this arrangement. It would have made a surprise attack on the camp more or less impossible, for example, and the dung produced by the livestock would, when dry, have provided a natural fuel for Israelite cooking fires, campfire fuel being otherwise difficult to procure for such a large population in a desert environment.

We may picture the Israelite camp as surrounded by a vast stockyard each night. Nighttime air in the camp would have been different from daytime air. Nighttime air would have been stockyard air-except for nights before sabbath. On those nights, the livestock were out in the fields rather than congregated together on the outskirts of the camp, and there would have been only normal desert air in the camp.

Stockyard air is just normal air loaded with many different gases from volatile compounds emitted by animals gases present in their breath, for example. One volatile compound that livestock give off is acetic acid (the acid in vinegar). If you leave vinegar open on the table, it will slowly evaporate into the air causing the air to smell like vinegar. The air of stockyards contains many such gases, creating a strong aroma distinct to each different type of stockyard animal.

Since the manna came with the dew, we may reasonably conjecture that certain of the stockyard gases with an affinity for water (the fundamental substance making up dew drops) concentrated in dew, where they reacted to form a substance which was left behind as a solid once the water had evaporated (i.e., manna).

Ammonia is the most abundant stockyard gas, which has a high affinity for water. Dew is aqueous and slightly acidic and when reacted with ammonia form a salt which can by isolated as a solid following evaporation. This leads to the conjecture that manna may be just crystals of ammonium acetate. However, this is not the case because the melting point of solid ammonium acetate is about 235° F. Manna, the biblical record tells us, melted when the sun grew hot. Yet the sun did not exceed 125 ºF at that time, much less 235 ºF. The second falsifying observation is that ammonium acetate is very difficult, if not impossible, to isolate from aqueous solution by simple evaporation. Thus, the ammonium acetate hypothesis proves to be false.

The second most abundant small acid, according to the published tables, is propionic acid. Its presence in stockyard air gives rise to the conjecture that manna may be just crystals of ammonium propionate. This hypothesis succeeds with the first three tests: 1) ammonium propionate is a white crystalline substance; 2) it has a melting point of 113 ºF, totally suitable to the biblical observation that manna melted when the sun grew hot; and 3) when treated with a hot air gun to blow 100 to 105° F. air over an inverted watch glass containing an aqueous solution of ammonium propionate, a solid crystalline residue remained when the liquid was gone. While is past other tests based on biblical observations, it was extremely difficult to obtain dry crystals synthetically. Instead, he crystals appeared somewhat translucent because of the moisture they retained, and when they were scraped off of a watch glass, they were sticky on the spatula. The idea that manna was sticky is absent from the biblical record. Manna seems to have been ready for collecting as soon as the dew had disappeared by evaporation. Despite its many successes, the ammonium propionate hypothesis seems to also be false.

The third most abundant small acid, according to the published tables of stockyard gases, is butyric acid. Its presence in stockyard air gives rise to the conjecture that manna may be just crystals of ammonium butyrate. However, this hypothesis is also plagued by the fact that the melting point of ammonium butyrate exceeds 150° F.

While other larger organic acids are present in stockyard air, their abundance is simply too small to support the amount of manna needed each day.

### B. The Stockyard Gas Efflorescence Theory of Manna

The hypotheses above pictured manna as a pure crystalline substance, like a snowflake, left behind when the water had evaporated from a dewdrop. And, what was excluded from the above as consideration was the environment of the desert where the Israelites were residing. The desert is short on leaves, and hence it is short on dewdrops. The desert is characterized by open ground-exposed soil. Dew does not sit in droplets on exposed soil the way it does on leaves. Like rain, dew soaks into soil. Desert soils contain water-soluble in-organic salts. When dew soaks into desert soils, these inorganic soil salts provide additional potential manna ingredients.

Desert soils are uniquely rich in water-soluble inorganic salts such as sodium chloride, sodium sulfate, and magnesium sulfate. Such salts are flushed down below the root zone of cultivated soils in non-desert regions by the passage of rainwater through these soils. But in the desert, there is insufficient rain to accomplish this, and water-soluble salts accumulate relatively high up in the vertical soil profile. When dew falls on such a soil, the liquid water comprising the dew soaks into the soil where it has potential to dissolve soil salts. The dissolution and consequent mobilization of soil salts may seem a simple matter, but it is not. Soils are porous. As a result, they absorb water. However, water-soluble ions are not completed removed from the soil by flushing with water, e.g., rain. Soil particles contain fixed negative charges on their surfaces. So the walls of a pore in the soil will be covered with fixed-in-place negative charges. These fixed charges can trap cations in the pore. Taking table salt as an example, Na+ ions can pair with wall-fixed negative charges, trapping the sodium cation in the pore, even when water is moving through the pore. This means that not all of a given water-soluble salt ion in a soil is freely available to be washed out of the soil by water. This brings us to efflorescence, i.e., the migration of a salt to the surface of a porous material where it forms a coating.

Efflorescence is a common occurrence on masonry brickwork where it is usually deemed an unsightly problem. Moisture entering the fabric of the bricks through their many pores dissolves available salts present in the bricks. When the water evaporates, a typically white efflorescence remains behind on the surface of the bricks. Now imagine for a moment a soil which has such a large amount of salt in it that the fixed negative charges on the walls of the pores of the soil are overloaded with cations and cannot trap any more. Meanwhile, more salt is present in the soil as free anion/cation pairs. Dew falling on such a soil will produce a salts-laden aqueous solution in the pores of the soil. When the sun comes up, warming the land, it causes the water to evaporate from this salts laden solution. Evaporation happens at the surface of the soil. As the surface water evaporates, its dissolved salts are left behind on the surface of the ground. Meanwhile, more salts laden dew water is drawn up to the surface by capillary action. This water also evaporates, depositing yet more salts at the surface, and on it goes until the soil is dry once again. The final result will be a layer of salts deposited on the surface of the desert soil. This layer may be vanishingly thin for light dew or soils with low concentrations of available salt, but it will be clearly visible for heavy dew on soils with high concentrations of available salt.

We may therefore picture nighttime, moisture-laden, stockyard air producing a heavy dew soaking the Negev desert soil overnight. Ammonia and small organic acids present in the stockyard air readily dissolve in the dew, and the resultant solution soaks into the soil. The ammonia adds ammonium cations, and the acids add their anions (such as acetate, propionate, and butyrate) to the ions already present in the pores of the soil. The ammonium cations interact with soil salt cations trapped on the walls of the pores, freeing some of them. In the morning, when the sun rises and warms the land, evaporating the water, an efflorescence of organic salts is produced, made up of soil salt cations paired with anions from the organic acids in the stockyard air, covering a large acreage of ground between the herds and the Israelite camp. This flake-like efflorescence is easily harvested as a reasonably clean food item by first fanning or blowing it into piles.

Like the stockyard gases theory of manna, the stockyard gases efflorescence theory of manna was tested. The knowledge of stockyard gases derived above was added to what water-soluble inorganic salts were present in Negev desert soils. The list of interesting potential ionic ingredients furnished by stockyard air to the manna recipe had numbered just four: ammonium, acetate, propionate, and butyrate. The addition of the seven soil ions above expands the list to eleven, giving rise to a very long list of potential candidate manna substance. However, manna efflorescence only appeared whenever stockyard gases were present. Thus, most of the matter making up manna efflorescence had to have come from the stockyard air, not from the ground. This means that the free soil anions can be ignored. They will be present in manna at trace levels only. The anions present in manna solution will be dominantly the stockyard air anions acetate, propionate and butyrate. This leaves only the soil cations as potentially of interest to manna.

A dominant characteristic of central Negev soils is that they tend to be highly\saline. They contain a great deal of sodium chloride (NaCl). This makes sodium abundant in these soils. The sodium cation, Na+, dominated the free salts of the upper 10 centimeters of the central Negev soil presently under consideration. It accounted for 89% of the cations measured in this surface soil layer. (Mg++ accounted for most of the remaining 11%, with K+ accounting for less than half a percent.) In the ancient Negev desert, some fraction of the relatively abundant ammonia in stockyard air would (in the form of ammonium in the dew saturated soil) have wound up exchanging places with the abundant sodium trapped in the surface layer of soil, thereby freeing sodium ions. This particular cation exchange process would have contributed sodium cations to the manna solution.

Based on the relative abundance of magnesium (11%, mentioned above) in the small free ion pool measured in this soil, significant Mg++ would be expected to be present in the cation exchange capacity (CEC). But because magnesium cation is doubly charged, it can be thought of as doubly trapped to the pore wall. This makes Mg++ more difficult than sodium, Na+, to free by exchange with ammonium so magnesium was likely to have been present in the manna solution in trace amounts only. In general, ammonium is a “stronger” cation than sodium, but a “weaker” cation than the other cations of interest to this desert soil such as potassium, magnesium, and calcium. “Stronger” cations may be expected to readily displace only “weaker” cations in cation exchange processes. Thus, when the manna solution evaporated at the surface, yielding the efflorescence mixture of organic salts called manna, it is the sodium salts of the organic acids found in stockyard air which may be expected to have dominated the efflorescence and given manna its distinctive properties.

As noted previously, acetic acid is the most abundant organic compound found in stockyard air, making acetate to be by far the most abundant anion in stockyard air dew. From a design perspective, with millions of Israelites to be fed, it makes sense that the most abundant stockyard air anion should be the main ingredient of manna. When an aqueous solution of sodium ions and acetate ions is evaporated near room temperature, a translucent crystalline solid containing three water molecules per sodium acetate molecule in its crystal lattice results. This solid is called sodium acetate trihydrate. It is a hydrate, as its name shows, and the water it contains is called “water of hydration.”

As just mentioned, sodium acetate trihydrate is a translucent crystal. This may seem immediately to disqualify it as a main ingredient of manna because manna, the biblical record explicitly states, was white. However, in warm dry air, sodium acetate trihydrate gives off some of its water of hydration, producing a whitest-of-whites coating of anhydrous sodium acetate. This release of water of hydration is also called efflorescence, further confusing the meaning of this over-taxed word. This kind of efflorescence—the spontaneous giving off of water molecules from a crystal to the air—may be thought of as the opposite of deliquescence, which is when a crystal absorbs water from the air to eventually dissolve and become a solution. Sodium acetate trihydrate is about as well behaved in normal room air as is table salt. It is easily crystallized from aqueous solution by evaporation of the water. The resulting crystals are not sticky and it was found sodium acetate trihydrate crystals left on the counter in the lab overnight at roughly 50% relative humidity were unchanged the next morning.

To test spoilage of sodium acetate trihydrate in high humidity conditions, a few crystals were placed in a small beaker, and then the beaker was placed in a closed Mason jar with a small amount of liquid water covering the floor of the jar, producing a high relative humidity in the jar. By the next morning, the crystals had spoiled by turning to water droplets on the bottom of the beaker. Clearly, sodium acetate trihydrate, while efflorescent in warm dry air, is deliquescent in moist air, resulting in a solid which matches both the biblically-recorded color and the biblically-recorded overnight spoilage observations of manna.

As a result of considerable experimentation, it was learned that the melting point test eliminated most manna candidates. Melting points generally tended to be far too high. Surprisingly, sodium acetate trihydrate passed this test. While anhydrous sodium acetate melts only at the high temperature of 615° F., the melting point of sodium acetate trihydrate is just 136° F. Pure sodium acetate trihydrate has this relatively low 136° F. melting point temperature because of the water molecules it contains in its crystal lattice. When the temperature reaches 136° F., these water molecules are released, causing solid sodium acetate trihydrate to “melt” by dissolution in its own water.

While 136 ºF is an unusually low melting point for the organic and inorganic salts of potential interest to manna, it is still on the high side relative to record highs in the Negev desert. As discussed previously, record high out door air temperatures in the central Negev are expected to be a few degrees less than 120° F., so manna comprised entirely of sodium acetate trihydrate would not melt in outdoor air in the central Negev. But, once it had been gathered, manna would have been kept indoors, not outdoors, and achieving an elevated temperature inside a closed tent exposed to direct sunlight is not difficult. In addition, the melting points of mixtures are generally depressed relative to pure compounds. In the present case, solid manna will not be pure sodium acetate trihydrate. Rather, it will be a mixture of mainly sodium acetate trihydrate with anhydrous sodium acetate plus other salts from less abundant ions present in the manna solution, such as sodium propionate and sodium butyrate. So the unusually low melting point of pure sodium acetate trihydrate seemed, in fact, to be just about right this was tested using the process described in Example 1 in the exemplification section below.

The flakes of the product were not at all sticky and the melting point of the flakes was below 129 ºF. This is only 10 or 11 Fahrenheit degrees above possible central Negev desert outdoor temperatures, an increase which is easily obtainable for a closed tent in direct sunlight. Thus, this manna candidate also passed the melting point test. As for the taste of manna, The main taste idea elicited by the Exodus observation, “its taste was like wafers with honey,” is sweetness, while with Numbers the main taste idea appears to be oiliness.

The taste of the product formed from Example 1 had an initial sensation of a brief, cool, mild sweetness reminiscent of artificial sweeteners. This was rapidly overwhelmed by a strong salty flavor left with a light aftertaste, or more precisely, a light aftersensation of oil/fat. While sodium acetate trihydrate is a suitable main ingredient of manna, it was clearly not the sole ingredient of manna.

When the emission ratios of the published measurements of stockyard air are averaged, acetic acid was found to comprise 86%, propionic acid 12%, and butyric acid 2% of the acids in this average stockyard air. See Bin Yuan et al., Supplement of Atmos. Chem. Phys., 17 (2017): 4945-4956, Table S5 (beef #1), Table S6 (beef #2), and Table S7 (sheep). This says that, in first approximation, for every 86 molecules of sodium acetate trihydrate in manna one might expect also to find in manna roughly 12 molecules of sodium propionate and roughly 2 molecules of sodium butyrate.

Another potential ingredient which is of some importance to the potential properties of manna, impacting especially its taste, is sodium hydroxide (NaOH). Sodium is freed from the soil by cation exchange with ammonium and that the abundance of ammonia far exceeds the abundance of the organic acids in stockyard air. This means that, in principle, sodium has potential to exceed the amount needed to pair with organic acid anions in manna solution. This excess sodium could pair with hydroxide anions (OH—) from ionization of water molecules in manna solution. The resulting manna efflorescence would then contain sodium hydroxide. The concentration of sodium in manna solution strongly impacts the taste of the finished manna. Too much sodium will yield a strongly basic manna with an unpleasant soapy taste from sodium hydroxide. Too little sodium will yield an acidic manna with a vinegar taste.

The biblical record leads us to expect manna to have neither an unpleasant soapy taste nor a vinegar taste. What is needed, to avoid these tastes, is just sufficient sodium to pair with the stockyard acids in manna solution and little more. The synthesis of manna is described by Example 2.

### C. Harmful Trace Substances

Harmful trace substances present in natural manna can be identified by examining the chemical compounds present in stockyard air. The first two columns of Table 1 show relative concentrations of volatile organic compounds (VOCs) measured in stockyard air from sheep plus their waste. The relative concentrations are given as the emission ratio (ER) of the specified VOC relative to ammonia in units of parts per trillion of the VOC to parts per billion of ammonia in the sheep stockyard air. This shows immediately that acetic acid is the most abundant VOC in sheep stockyard air, followed by methanol and then ethanol.

TABLE 1
Relative abundance of sheep stockyard VOCs in manna solution.

| VOC | ER | HC | RA |
|---|---|---|---|
| Acetic Acid | 33.61 ± 1.13 | 4.0E+01 | 1.0 |
| Propionic Acid | 2.44 ± 0.10 | 7.1E+01 | 0.1 |
| Butyric Acid | 0.33 ± 0.02 | 4.3E+01 | 0.0 |
| C5 Acid | 0.07 ± 0.01 | 2.3E+01 | 0.0 |
| C6 Acid | 0.01 ± 0.00 | 1.3E+01 | 0.0 |
| C7 Acid | 0.00 ± 0.00 | 1.5E+01 | 0.0 |
| Ethanol | 17.05 ± 0.49 | 1.9E+00 | 0.0 |
| Methanol | 21.3 ± 2.0 | 2.0E+00 | 0.0 |
| CH₃CHO | 1.24 ± 0.11 | 1.3E−01 | 0.0 |
| Acetone | 4.00 ± 0.13 | 2.7E−01 | 0.0 |
| MEK | 2.05 ± 0.08 | 1.8E−01 | 0.0 |
| Acrolein | 0.13 ± 0.02 | 1.3E−01 | 0.0 |
| MVK + MACR | 0.17 ± 0.02 | 4.0E−01 | 0.0 |
| C₄H₆O₂ | 0.44 ± 0.03 | 2.2E−02 | 0.0 |
| Phenol | 0.55 ± 0.02 | 1.8E+01 | 0.0 |
| Cresol | 0.34 ± 0.01 | 1.3E+01 | 0.0 |
| H₂S | 9.40 ± 1.94 | 1.0E−03 | 0.0 |
| CH₄S | 0.49 ± 0.04 | 1.0E−03 | 0.0 |
| C₂H₆S | 0.17 ± 0.02 | 1.0E−03 | 0.0 |
| C₃H₈S | 0.01 ± 0.00 | 1.3E−03 | 0.0 |
| DMDS | 0.01 ± 0.00 | 5.8E−03 | 0.0 |
| DMA | 0.02 ± 0.01 | 5.5E−01 | 0.0 |
| TMA | 0.20 ± 0.01 | 9.9E−02 | 0.0 |
| Formamide | 0.26 ± 0.02 | 7.1E+03 | 1.4 |
| Acetamide | 0.07 ± 0.01 | 5.3E+03 | 0.3 |
| Propanamide | 0.03 ± 0.01 | 3.3E+03 | 0.1 |
| Indole | 0.00 ± 0.00 | 1.9E+01 | 0.0 |

The abundance of sheep stockyard VOCs in manna solution can be calculated by multiplying the ER of a given VOC (which gives its abundance in the air) by Henry's constant (which gives its affinity for water as opposed to air). For ease of comparison, this is shown this as a relative abundance (RA) in the final column of Table 1, where the abundance of each VOC in manna solution has been divided by the abundance of acetic acid in manna solution. This shows immediately that most sheep stockyard VOCs will have no significant abundance in manna solution. In contrast to this general trend, the “amide” compounds stand out, and formamide stands out most conspicuously. It gives a relative abundance in manna solution 40% greater even than that of acetic acid, the main ingredient of manna.

Formamide will be present as a significantly abundant trace substance in finished manna. It will be present 1) because its large Henry's constant means it will partition from stockyard air into dew, making it significantly abundant in manna solution, and 2) because formamide, which is an oily liquid at room temperature, has a low vapor pressure, over two hundred times less than the vapor pressure of water at room temperature, meaning that formamide will be left behind as a trace substance on natural manna crystals once the water has evaporated from them. Thus, eating natural manna as a major staple year after year, as the Israelites wound up doing during the Exodus, will necessarily entail chronic ingestion of significant amounts of formamide.

The amount of formamide ingested may be estimated as follows. The concentration of acetic acid in Israelite Negev desert stockyard dew at the surface of the ground has previously been calculated to be 1.2×10⁻⁴ mole/L. So the concentration of formamide in the dew will be (1.4×1.2×10⁻⁴=) 1.7×10⁻⁴ mole/L. Meanwhile, the concentration of sodium acetate trihydrate (SAT) in manna solution has been shown to be roughly 1.5×10⁻² mole/L (approximating the composition of manna to be 100% sodium acetate trihydrate). So the mass of formamide eaten per kilogram of natural manna is (1.7×10⁻⁴ moles formamide/L×45 g formamide/mole formamide/1.5×10⁻² mole SAT/L×136 g SAT/mole SAT=) 3.8×10⁻³ kilogram formamide.

The consumption of manna was roughly a gallon per person per day. This weighed roughly 1.6 kilograms. So each person was daily consuming up to 6 grams of formamide. This amounts to about a teaspoon of formamide per person per day. Formamide is suspected of causing cancer, has reproductive effect, developmental effect, and teratogenicity. It thus appears that the zero population growth experienced by the Israelites while they lived in the desert may have resulted from the presence of formamide as a harmful trace substance in the natural manna which they ate, dramatically reducing their rate of conception. As used herein “free from formamide” means that no detectable amount of formamide is present.

### EXEMPLIFICATION

All chemicals were purchased from Millipore-Sigma.

### Example 1—Manna Candidate Recipe

To 10 ml of distilled water was added 0.44 grams of sodium acetate trihydrate, 0.044 grams of sodium propionate, and 0.0070 grams of sodium butyrate. Evaporation of the water from 0.465 ml of this solution on a watch glass using a stream of dried, 85 ºF air at 2 liters per minute yielded 0.022 grams of thoroughly dry solid in 90 minutes. When scraped off the watch glass, this gave a fine, flake-like, white solid, matching the biblical description of manna.

### Example 2—Manna Synthesis

To 100 ml of distilled water in a container suitable for mixing (e.g., a 250 ml beaker), 29 grams of sodium acetate trihydrate and 0.85 grams of sodium propionate are added and mix well until completely dissolved. A glass dish was weighed and the resulting manna solution was poured out into the glass dish. The water was evaporated in a dehydrator at 125 ºF for 3 hours. The liquid slowly disappears and, with about half an hour remaining, a dull crust appears. Once the crust completed its formation across the entire solution, a narrow spatula was used to scrape the damp product up off the glass, leaving the scraped up product into a brownie dish. The container plus manna clumps were weighed at this stage to calculate the weight of the product.

Dehydration was continued with frequent stirring until the weight of the product is 29 g. The manna continued to whiten during this final dehydration. At 29 grams, dehydration was stopped because excessive dehydration will convert an excessive amount of sodium acetate trihydrate to anhydrous sodium acetate, evidenced by a low final product weight and the lack of a suitable melting point, ruining the batch. Finally, the final product is passed through a mesh having eight wires per inch to achieve a size distribution suitable to the biblical “fine, flake-like” description. The product will keep indefinitely if stored in an air-tight jar.

The above recipe specifies a proportion of sodium propionate to sodium acetate trihydrate which has the greatest probability of matching native Negev desert manna based on available data. Nonetheless, variations in this ratio are obviously possible as 1) the emission ratios for propionic acid relative to acetic acid for the three ER tables underlying this recipe display variations of as much as 50%, 2) the composition of Israelite livestock would have differed from those used in the construction of these tables, and 3) the native Negev animal diet would have differed from the diets used in the construction of these tables. None of these factors is expected to make a significant difference to the properties of manna because of the overriding dominance of sodium acetate trihydrate in all cases.

The ingredients specified in the recipe have been chosen for their ready commercial availability and their safety in handling and transport. Nonetheless, ingredient substitutions are obviously possible. For example, anhydrous sodium acetate could be substituted in equal molar amount for sodium acetate trihydrate. As a second example, sodium acetate trihydrate could be substituted by an equal molar amount of sodium hydroxide plus an equal molar amount of acetic acid. As a third example, sodium propionate could be substituted by an equal molar amount of sodium hydroxide plus an equal molar amount of propionic acid.

1. A mixture of sodium acetate trihydrate and sodium propionate, wherein the sodium acetate trihydrate is present in an amount of about 1 mole to about 10 mole per about 50 mole to about 200 moles of sodium acetate.

2. The mixture of claim 1, wherein the sodium acetate trihydrate is present in an amount of about 3 mole to about 7 mole per about 75 mole to about 150 moles of sodium acetate.

3. The mixture of claim 1 or 2, wherein the sodium acetate trihydrate is present in an amount of about 4 mole to about 5 mole per about 75 mole to about 125 moles of sodium acetate.

4. The mixture of any one of claims 1 to 3, wherein the sodium acetate trihydrate is present in an amount of about 4.2 mole per about 100 mole of sodium acetate.

5. The mixture of any one of claims 1 to 4, further comprising sodium butyrate.

6. The mixture of any one of claims 1 to 5, wherein the mixture is in solid form.

7. The mixture of any one of claims 1 to 6, wherein the mixture has a melting point of less than about 130° F.

8. The mixture of any one of claims 1 to 7, wherein the mixture is suitable for human consumption.

9. The mixture of any one of claims 1 to 8, wherein the mixture is free from formamide.

10. The mixture of any one of claims 1 to 4 and 6 to 9, wherein the mixture consists of sodium acetate trihydrate and sodium propionate.

11. The mixture of any one of claims 1 to 10, wherein the mixture is in the form of a composition.

12. A process for preparing a mixture of any of the preceding claims, said process comprising
dissolving said sodium acetate trihydrate and said sodium propionate (add optionally said sodium butyrate) in water; and
evaporating the water to obtain said mixture.

13. The process of claim 12, wherein said evaporation is performed with a dehydrator.
